(19) United States
(12) Patent Application Publication
(10) Pub. No.: US 2014/0178693 A1
(43) Pub. Date: Jun. 26, 2014

(54) HIGH THERMAL CONDUCTIVITY COMPOSITE FOR ELECTRIC INSULATION, AND ARTICLES THEREOF

(71) Applicant: GENERAL ELECTRIC COMPANY, Schenectady, NY (US)

(72) Inventor: Wei Herbert Zhang, Ballston Lake, NY (US)

(73) Assignee: GENERAL ELECTRIC COMPANY, Schenectady, NY (US)

(21) Appl. No.: 13/723,465

(22) Filed: Dec. 21, 2012

(51) Int. Cl. H01B 3/40

(52) U.S. Cl. CPC H01B 3/40
USPC 428/413; 252/73; 252/74

(57) ABSTRACT

A thermally-conductive and electrically-insulating composite composition is provided. The composite composition includes an epoxy resin and a filler. The epoxy resin has at least two epoxide groups per molecule, and a reactive diluent. The composite composition includes about 5 volume percent to about 20 volume percent of the filler, based on the total volume of the composite composition. An electrical component having a coating of the composite composition is also provided.

### BACKGROUND OF THE INVENTION

The invention relates generally to electric insulation, and more specifically relates to a composite composition with improved thermal conductivity used for the insulation of electrical machines, for example, coils for motors and generators.

The power density of electrical machines, for example motors and generators, is typically limited, due to the difficulty in removing the heat generated by the copper windings in stators and rotors. The heat transfer is generally impeded by the low thermal conductivity of electrically insulating materials used on the copper windings. Insulation materials for such applications generally include glass cloth, glass fiber, mica tape, thermoplastic film and similar materials. Such insulating materials generally need to have the mechanical and the physical properties that can withstand the various electrical rigors of the electrical machines, while providing adequate insulation. In addition, the insulation materials should withstand extreme operating temperature variations, and provide a long life.

Generally, these insulating materials, such as mica tapes, are impregnated with curable polymeric materials before application to the copper windings, i.e., pre-impregnated, or afterwards, by a vacuum impregnation technique. In either case, a resin composition must be applied and cured in place without voids, since those voids can reduce the useful life of the insulation, e.g., as a result of breakdown under electrical stress. For this reason, the resin composition must be effectively solvent-free. At the same time, the resin must exhibit relatively low viscosity, for easy flow around and between the windings of a coil, and for efficient penetration in the preparation of pre-impregnated materials.

For these types of applications, epoxy resins are usually preferred to polyester resins, because of their substantially superior characteristics of thermal stability, adhesion, tensile, flexural and compressive strengths, and resistance to solvents, oils, acids and alkalis. However, the viscosity of these resins is typically high, e.g., on the order of 4,000 to 6,000 centipoises (cps), or greater. When certain hardeners are added, their viscosities can be in the range of 7,000 to 20,000 cps, which is often much too high for useful impregnation purposes. While a viscosity of that sort can be reduced substantially through the use of certain epoxy diluents, some of the attempts along this route in the past have only served to decrease the thermal stability of the compositions, thereby compromising the insulating properties.

In recent years, the thermal conductivity of the general insulation has improved, e.g., from about 0.2 W/mK to about 0.5 W/mK, via the addition of inorganic fillers into the polymeric material. These fillers are thermally conducting, but electrically insulating. However, a high level of fillers in the insulating materials may detract from the dielectric properties of the material. For instance, most inorganic fillers have a higher dielectric constant relative to the insulating material, which tends to increase the overall dielectric constant of the composite insulating material. If the dielectric constant of the material is too high, it may limit the applications in which the material can be used. In addition, the insulating material containing these fillers may be more brittle than the unfilled material.

There is thus a need for high thermal-conductivity insulating materials that can improve heat transfer in electrical machines.

### BRIEF DESCRIPTION

Embodiments of the invention are directed toward a composite coating for the insulation of electrical machines.

In one embodiment, a thermally-conductive and electrically-insulating composite composition includes an epoxy resin and a filler. The epoxy resin has at least two epoxide groups per molecule, and includes a reactive diluent. The composite composition includes about 5 volume percent to about 20 volume percent of the filler, based on the total volume of the composite composition.

Another embodiment of the invention is directed to an electrical component having a coating of a composite composition for electric insulation. The composite coating includes an epoxy resin and a filler. The epoxy resin has at least two epoxide groups per molecule, and includes a reactive diluent. The coating includes about 5 volume percent to about 20 volume percent of the filler, based on the total volume of the composite composition.

### DRAWINGS

These and other features, aspects, and advantages of the present invention will become better understood when the following detailed description is read with reference to the accompanying drawings, wherein:

FIG. 1 is a schematic view of a composite composition containing a filler, in accordance with an embodiment of the invention,

FIG. 2 is a cross-sectional view of a conductor bar wrapped with mica tape, coated and impregnated with a composite composition, in accordance with an embodiment of the invention;

FIG. 3 is an enlarged fragmentary sectional view of an electrical conductor provided with a vacuum-impregnated composite composition, in accordance with an embodiment of the invention;

FIG. 4 is a graph showing comparative thermal conductivities of a comparative sample and an inventive sample.

### DETAILED DESCRIPTION

The invention includes embodiments that relate to a composite composition that may be applied or used on an electrical machine, e.g., copper windings in a stator or a rotor, for electric insulation. The “composite composition” may also be referred to as “composite material” or “insulating material, or “insulation material” throughout the specification.

As discussed in detail below, some of the embodiments of the present invention provide a highly thermally-conductive composite composition (or “material” or “varnish”) for the electric insulation of electrical machines, and an electrical machine using the same. These embodiments advantageously provide improved coatings of high thermal conductivity for the electric insulation, without detrimentally affecting other insulation features such as dielectric properties, electrical resistivity, electric strength, thermal stability, and the coefficient of thermal expansion, in addition to viscoelastic features such as linear viscoelasticity, non-linear viscoelasticity, dynamic modulus.

When introducing elements of various embodiments of the present invention, the articles “a,” “an,” “the,” and “said” are intended to mean that there are one or more of the elements. The terms “comprising,” “including,” and “having” are intended to be inclusive, and mean that there may be additional elements other than the listed elements. As used herein, the term “and/or” includes any and all combinations of one or more of the associated listed items.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances the event or capacity cannot occur. This distinction is captured by the terms “may” and “may be”.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value.

Some embodiments of the invention provide a thermally-conductive and electrically-insulating composite composition. The insulating composition comprises an epoxy resin and a filler. The epoxy resin includes an epoxy material having at least two epoxide groups per molecule, and a reactive diluent. The epoxy resin may further contain small but effective amounts of one or both of a phenolic accelerator and a catalytic hardener. The hardener does not contain a metal halide or a compound containing a metal-halogen bond. Various epoxy resins of present interests are described in detail in the U.S. Pat. No. 4,603,182, incorporated by reference herein.

Some examples of suitable epoxy materials may include Bisphenol A diglycidyl ether epoxy resins (such as those sold under the trademarks EPON® 826 and EPON 828 by Shell Chemical Co.). Other liquid resins of this formulation (such as those marketed under the trademarks DER™ 330, 331 and 332 by Dow Chemical Company, Epi-REz® 508, 509, and 510 by Celanese Corporation and Araldite® 6004, 6005 and 6010 by Ciba-Geigy). Still other suitable resins of this type are epoxy novolac resins (such as DEN™ 431 and DEN 438 of Dow Chemical Company and Epi-Rez SU-2.5 of Celanese Corp.), halogenated epoxy resins (such as Araldite 8061 of Ciba-Geigy) and cycloaliphatic epoxy resins (such as ERL 4206, 4221, 4221E, 4234, 4090 and 4289 of Union Carbide and Araldite CY182 and 183 of Ciba-Geigy).

The catalytic hardener and the accelerators provide the desired cure rate, and can enhance the electrically-insulating and physical property characteristics of the end product. Various hardeners and accelerators suitable for the compositions of the present invention are described in the U.S. Pat. No. 4,603,182. The hardener for the chosen epoxy resin or mixture of resins will generally consist of a mixture of a phenolic accelerator and a labile halogen-free organic titanate or metal acetylacetonate. The quantity of the phenolic accelerator will usually be between about 0.1% and about 15% by weight of the epoxy resin, while the other constituent will be used in the amount of about 0.025% to about 5% by weight on the same basis when it is a metal acetylacetonate; and about 0.05% to about 10% by weight when it is an organic titanate. In specific embodiments, catechol is desirable accelerator.

The reactive diluent decreases the viscosity of the epoxy resins. In particular, styrene, alpha-methyl styrene, an isomer or mixture of isomers of vinyl toluene, of t-butyl styrene, of divinyl benzene, and of diisoprophenyl benzene, and combinations thereof, are the compounds of choice within the scope of this invention to reduce the viscosity of the epoxy resins. In some particular embodiments, the reactive diluent may be an isomer of vinyl toluene i.e., ortho-, meta-, para-vinyl toluene, or a combination thereof. In some other particular embodiments, the reactive diluent may be an isomer of t-butyl styrene, i.e., ortho-, meta-, para-t-butyl styrene, and a combination thereof. The amount of the reactive diluent or combination of diluents used may be between about 3% and about 33% by weight of the total composition. In certain embodiments, the amount of the reactive diluent may be between about 5% and about 20% by weight for desirable results.

The various constituents, e.g., the hardener, accelerator, and diluents, may be compounded altogether, or in a sequence with the epoxy resin. In some embodiments, it was observed that mixing the constituents in a particular sequence may be effective for obtaining the required features of the epoxy resin.

These epoxy resins that include the hardener, the accelerator, and the diluent, as discussed above, usually have a relatively low viscosity at about 25 degrees Celsius, e.g., less than about 3000 cps, and in certain instances, less than about 1000 cps, as described in U.S. Pat. No. 4,603,182.

These epoxy resins can be applied as a coating, a layer or a film on the insulating materials, e.g., insulating papers and mica tapes. The resin is usually impregnated on the insulation material. This can be done before or after application of these tapes or layers to electrical components, by pre-impregnation or post-impregnation, e.g., by a vacuum pressure impregnation technique. Other techniques may include a doctor blade technique, spraying, sprinkling, extrusion coating, and other methods known in the art.

Typically, these impregnated coatings or layers are then cured at an elevated temperature. Cured epoxy resins show good adhesion to the base insulating materials, e.g., copper. Upon curing, these low viscosity epoxy resins, unlike many other polymers, desirably exhibit high shrinkage properties, and do not liberate volatile products. The term “shrinkage”, as used herein is generally defined as the proportionate decrease in a dimension or volume of a material (e.g., an epoxy resin) caused by a change in temperature, a physical process or a chemical process, or a phase change of the material, etc. A decrease in a dimension (e.g., a planar dimension like length) refers to “linear shrinkage”, and a decrease in the volume of a material refers to “volume shrinkage.” The linear shrinkage of a material is generally about ⅓ of the volume shrinkage of the material. In some embodiments, the epoxy resin shows a linear shrinkage between about 1 percent and about 4 percent, and a volume shrinkage between about 3 percent and about 12 percent upon curing, at about 150 degrees Celsius. A low shrinkage material usually has a linear shrinkage up to about 0.5 percent. In specific embodiments, the volume shrinkage of the epoxy resins may range between about 6 percent and 12 percent. The volume shrinkage of the epoxy resins may be adjusted by varying the amount of the reactive diluent in the composition.

As noted above, high thermal conductivity fillers are added to the epoxy resin, so as to improve the thermal conductivity of the resin, and form a high thermally-conductive composite composition. Examples of suitable high thermal conductivity fillers may include boron nitride (BN), aluminum nitride (A1N), silicon nitride (Si₃N₄), and alumina (Al₂O₃). Other similar materials such as magnesium oxide (MgO), silicon carbide, or diamond (Carbon), may also be used. In specific embodiments, hexagonal boron nitride is desirable filler. Boron nitride possesses a thermal conductivity of about 270-300 W/m-k. Furthermore, boron nitride has relatively low hardness as compared to some of the other mentioned fillers. Such a material may be very useful in providing a high thermal conductive layer or coating that has good toughness, and that is less susceptible to a thermal expansion mismatch.

The phonon distribution is generally responsible for thermal transport within a material. Enhanced phonon transport and reduced phonon scattering attribute to high thermal conductivity in a material. Larger particles may increase the phonon transport, while smaller particles may affect the phonon scattering. Thus, the particle size of the filler may be sufficient to sustain these effects, and to satisfy inter-particle distance (or inter-particle spacing) requirements for reduced phonon scattering, and enhanced phonon transport. In addition, the size distribution of the filler particles may be chosen to fulfill the desired objective in relation to the voids in the host insulating tapes or layers. In one embodiment, the average particle size of the filler may range between about 10 nm and 100 microns. In some embodiments, the average particle size ranges from about 100 nm to about 100 microns, and in a certain embodiment, between about 30 microns to about 75 microns.

The distribution of particles within the epoxy resin is another consideration. The high thermal conductivity fillers are generally dispersed in the epoxy resin so that the filler particles may form an ordered network structure having short and longer range periodicity. The ordered network structure of filler particles, along with suitable particle size and inter-particle spacing, may reduce phonon scattering, and provide phonon transport to produce good thermally conductive interfaces within the filler material. In some embodiments, the filler particles are uniformly distributed throughout the epoxy resin. In some embodiments, the filler particles are randomly distributed.

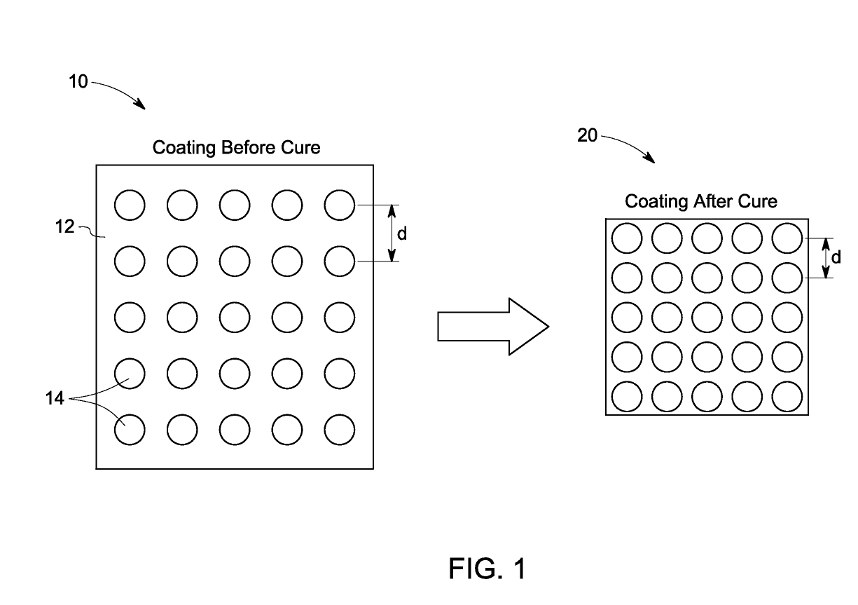

An inter-particle spacing, as used herein, refers to a mean center-to-center distance between the two adjacent particles in an ordered network. FIG. 1 (also described below) shows inter-particle spacing ‘d’ between the two adjacent particles 14 of the filler, uniformly dispersed in a high shrinkage epoxy resin 12. Apart from the particle size, the reduction in the inter-particle spacing between the filler particles may depend on other parameters, such as the amount of the filler, and the distribution of filler particles. Higher levels of filler dispersed in the epoxy resin will usually result in a decrease in the inter-particle spacing between the filler particles. However, a higher amount of the filler may not always be desirable, because it can lead to some decrease in the dielectric properties of the resin.

In one embodiment, an electrical component comprises a coating of the composite composition. An illustration can relate to an electrical component that includes copper windings on a conductor bar. The coating can be applied on an insulating base material, such as mica tape, before or after application of such a tape on the copper windings. In one embodiment, the coating of the composite composition is applied by an impregnation technique, e.g., pre-impregnation or post-impregnation techniques. For brevity of discussion, these coatings of the composite composition may also be referred to as “composite coatings.” The composite coating may be cured by heating the coating at a selected temperature, under atmospheric conditions. In one embodiment, the curing temperature may be between about 150 degrees Celsius to about 170 degrees Celsius. In one embodiment, the composite coating may be cured under pressure (e.g., about 80 psi to about 100 psi).

Without being bound by any theory, the high volume shrinkage of the epoxy resins, as discussed previously, is the key to achieve high thermal conductivity composite coatings. The filler is dispersed in the epoxy resin, and the resulting composite composition is coated on the insulating base material, and cured. Upon curing, the inter-particle spacing between the filler particles is reduced, which may enhance the phonon transport, and thus may help to achieve high thermal conductivity in these epoxy resin composite coatings. FIG. 1 shows a schematic view for such a scenario. As illustrated, FIG. 1 indicates a composite coating before and after curing as 10 and 20, respectively. The composite coating (10 and 20) has filler particles 14 uniformly dispersed in an epoxy resin 12. Before curing, the coating 10 contains filler particles 14 with an inter-particle spacing “d”. After curing, the inter-particle spacing between the filler particles 14 is reduced to “d′” (d′<d) in the coating 20.

The composite coatings (or “varnishes”), according to most embodiments of the present invention, have high thermal conductivity. In one embodiment, the thermal conductivity of the composite coatings or varnishes may range from about 1 W/m-K to about 3 W/m-K. For example, FIG. 4 shows improved thermal conductivity of a composite composition that is described in detail below. Usually, a high amount (more than about 30 volume percent) of a filler (e.g., BN) is required to attain the same level of thermal conductivity when added to other known varnishes. However, according to the embodiments of the invention, much lower amounts of the filler can be used to achieve the high thermal conductivity when added to and combined with the epoxy resin. In some embodiments, the filler may be present in the composite composition in an amount from about 5 volume percent to about 20 volume percent. In particular embodiments, the filler may be present in an amount from about 8 volume percent to about 15 volume percent.

Furthermore, the composite compositions or coatings have excellent dissipation factors. The “dissipation factor” is a measure of the loss-rate of the electromagnetic field through a dielectric layer. A lower dissipation factor correlates with a lower amount of energy that is lost, or absorbed through the dielectric layer. The amount of the filler and size of the filler particles may affect the dissipation factor of the composite composition. In general, the presence of the filler can desirably lower the dissipation factor of the composite composition. The low dissipation factors of the composite compositions make them more useful in electrical insulation applications. The dissipation factor of the composite composition at room temperature and 60 Hz may be about 0.5%, and at about 150 degrees Celsius and 60 Hz, may be about 1.5%.

The embodiments of the present invention thus provide high thermal conductivity composite compositions for electrical insulation. The attributes described above can improve the heat transfer between or within the various components of an electrical machine, for example, the copper windings, and can improve the power density of the machine. The composite compositions advantageously attain high thermal conductivity with relatively low amounts of the filler, and therefore show improved heat transfer, without sacrificing features such as dielectric properties, other electrical properties, and viscoelastic characteristics. The composite compositions, in the form of hard, tough solids, have excellent electrical properties over the range from 25 degrees Celsius to about 170 degrees Celsius in their cured form. They are also substantially free of ionic species which tend to reduce the effectiveness of the insulation at elevated temperatures. The low viscosity of these compositions leads to ease of manufacturability i.e., easy application of coatings on electrical components.

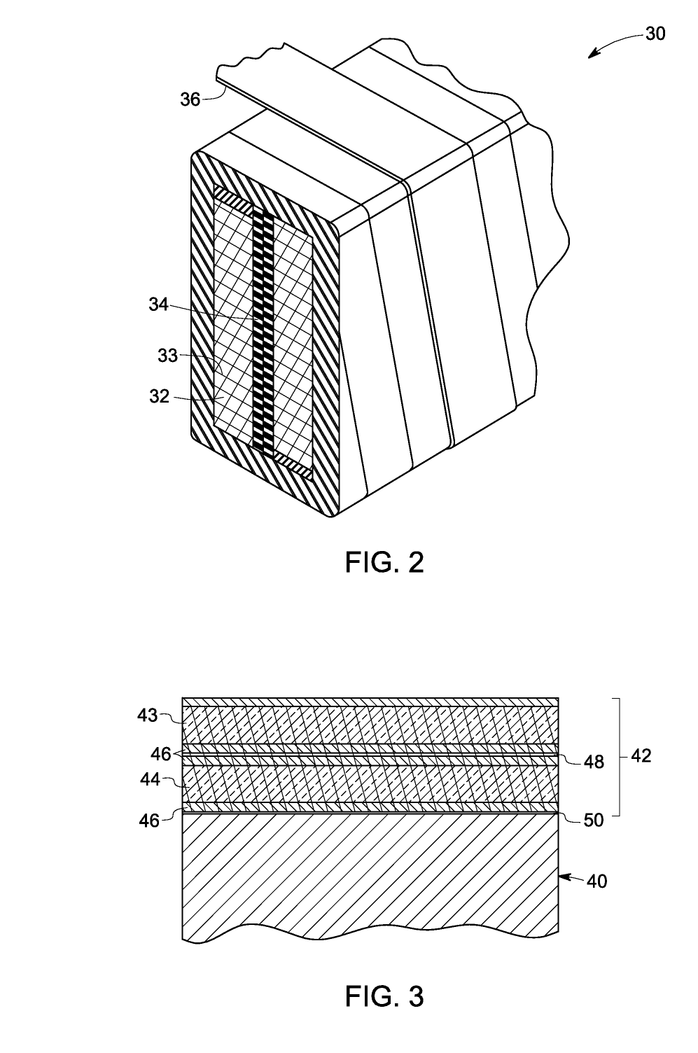

When glass fabric, mica paper, mica tape or the like are impregnated with the composite compositions of the present invention, according to some embodiments, the resulting sheets or tapes can be wound by hand or by machine for insulation on electrical components, such as the conductor bar shown in FIG. 2. A typical conductor bar 30, as illustrated, having a plurality of conductor turns or windings 32, insulated from each other by insulation 33, has arrays of conductors separated by strand separators 34. Wrapped around the winding bar is a plurality of layers of mica paper tape 36, coated and impregnated with the composite composition of the present invention. In preparing such an insulated conductor bar, the entire assembly is covered with a sacrificial tape, and placed in a pressure tank and evacuated. The only purpose of the evacuation is to remove entrapped air. After vacuum treatment, molten bitumen, or some other type of heated transmitting fluid, is introduced into the tank under pressure, so as to cure the composition in a well-known manner. Upon completion of the curing step, the bar is removed from the bath, cooled, and the sacrificial tape is removed.

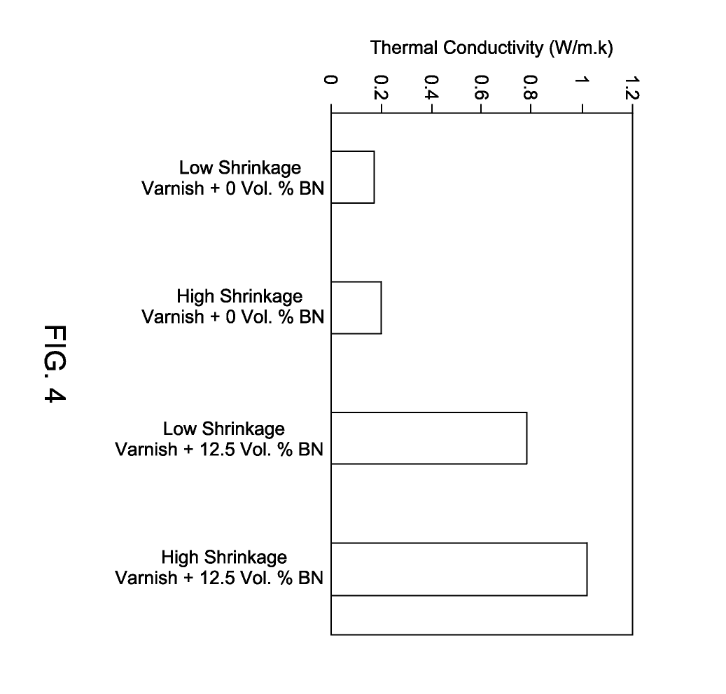

FIG. 3 is an enlarged fragmentary sectional view of an electrical conductor 40, provided with vacuum-impregnated insulation 42, in accordance with an exemplary, non-limiting embodiment of the invention. There are two layers of mica paper 43 and 44, with reinforcement or backing material 46, with a small space 48 between the two layers. There is a space 50 between the inner tape layer 44 and conductor 40. Spaces 48 and 50 are filled with the composite composition; and the tape layers 43 and 44 are coated with the composite composition. Such filling of this insulating structure, and the void-free nature of the conductor covering, are attributable to the low viscosity of the impregnating composition.

It will be understood from the foregoing that as an alternative to the procedure described above, the composite composition of this invention can be applied to such fabric or tape or paper, prior to the application thereof to the conductor to be insulated thereby, using the standard impregnation and application techniques, by employing the novel compositions of this invention.

### EXAMPLES

The example that follows is merely illustrative, and should not be construed to be any sort of limitation on the scope of the claimed invention.

### Comparative Sample

### Composite Composition Using a Low Shrinkage Resin

A resin composition was prepared from about 50 weight percent Bisphenol A—diglycidyl ether epoxy, about 50 weight percent 1,3-isobenzofurandione, hexahydromethyl-Methyl Hexahydrophthalic Anhydride, and about 1-2% boron trichloride-amine complex. 12.5 volume percent boron nitride having an average particle size of 60 microns (from Momentive Performance materials) was dispersed in the liquid resin composition, using a high speed planetary shear mixer under vacuum, and mixed for different periods of time, so as to achieve a homogeneous particle dispersion. The resulting BN-containing resin composition (varnish 1) was coated on a 1″-wide mica tape by a doctor blade coater technique, and cured at about 150 degrees Celsius for about 20 minutes, to achieve a b-stage of the coated tape, prior to taping this coated tape onto a copper bar. The coated tape was then applied on the copper bar, and the taped copper bar was cured again at about 150 degree Celsius for about 6 hours.

### Inventive Sample

### Composite Composition Using a High Shrinkage Epoxy Resin

A high shrinkage resin composition was prepared by mixing about 70 weight percent Bisphenol A—diglycidyl ether epoxy resin, about 15 weight percent vinyl toluene, about 10 weight percent phenol novolac, and about 5 weight percent catechol. About 12.5 volume percent boron nitride, having an average particle size of 60 microns (from Momentive Performance materials), was dispersed into the liquid resin composition, using a high speed planetary shear mixer under vacuum, and mixed at different periods of time, so as to achieve a homogeneous particle dispersion. The resulting BN-containing composite composition (varnish 2) was coated on a 1″-wide mica tape by a doctor blade coater technique, and cured at about 150 degrees Celsius for about 20 minutes to achieve a b-stage of the coated tape, prior to taping this composite tape on to a copper bar. The coated tape was then applied on the copper bar, and the taped copper bar was cured again at about 150 degree Celsius for about 6 hours.

FIG. 4 shows a comparison, in thermal conductivity, for the low shrinkage and high shrinkage resins, with and without boron nitride fillers. The low shrinkage epoxy resin and the high shrinkage epoxy resin have comparative thermal conductivity. However, the inventive sample (high shrinkage epoxy resin with BN filler) had much higher thermal conductivity, as compared to the comparative sample (low shrinkage resin with BN filler). It is clear that the inventive sample (varnish 2) shows much more improvement in thermal conductivity, as compared to the comparative sample (varnish 1), with same amount of BN filler.

Though the present discussion provides examples in the context of an insulating composite composition for electrical machines used in electrical industries, typically in starter motors and generators, and industrial motors, the insulating composition or varnish is equally applicable in other areas. Industries that need to increase heat transference would equally benefit from the present invention. Examples include energy, chemical processes and manufacturing industries, inclusive of oil and gas, and the automotive and aerospace industries. Other focal points include power electronic, conversion electronics and integrated circuits, where the increasing requirement for enhanced density of components leads to the need to remove heat efficiently from various regions of the components.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A thermally-conductive and electrically-insulating composite composition comprising an epoxy resin having at least two epoxide groups per molecule, and a reactive diluent, and about 5 volume percent to about 20 volume percent of a filler, based on the total volume of the composite composition.

2. The composite composition of claim 1, wherein the reactive diluent is present in an amount between about 3 weight percent and about 33 weight percent, based on the total weight of the epoxy resin.

3. The composite composition of claim 1, wherein the reactive diluent is selected from a group consisting of styrene, alpha-methyl styrene, an isomer or mixture of isomers of vinyl toluene, an isomer or mixture of isomers of t-butyl styrene, an isomer or mixture of isomers of divinyl benzene, and an isomer or mixture of isomers of diisopropenyl benzene, and combinations thereof.

4. The composite composition of claim 1, wherein the reactive diluent comprises ortho-, meta-, para-vinyl toluene, or a combination thereof.

5. The composite composition of claim 1, wherein the reactive diluent comprises ortho-, meta-, para-t-butyl styrene, or a combination thereof.

6. The composite composition of claim 2, wherein the reactive diluent is present in an amount between about 5 weight percent to about 20 weight percent.

7. The composite composition of claim 1, wherein the epoxy resin further comprises a phenolic accelerator in an amount between about 0.1 weight percent and about 15 weight percent, based on the total weight of the epoxy resin.

8. The composite composition of claim 1, wherein the epoxy resin has a viscosity less than about 3000 cps at 25 degrees Celsius.

9. The composite composition of claim 8, wherein the epoxy resin has a viscosity varying from about 100 cps to about 1000 cps at 25 degrees Celsius.

10. The composite composition of claim 1, wherein the epoxy resin has a volume shrinkage ranging from about 6 percent to about 12 percent.

11. The composite composition of claim 1, wherein the filler comprises a material selected from the group consisting of boron nitride, aluminum nitride, silicon nitride, and alumina.

12. The composite composition of claim 1, wherein the filler is present in an amount between about 8 volume percent and about 15 volume percent.

13. The composite composition of claim 1, wherein the filler comprises particles of an average size from about 100 nm to about 100 microns.

14. The composite composition of claim 1, wherein the filler is uniformly dispersed in the epoxy resin.

15. An electrical component that is at least partially covered with a coating of a composite composition that comprises an epoxy resin having at least two epoxide groups per molecule, and a reactive diluent, and about 5 volume percent to about 20 volume percent of a filler, based on the total volume of the composite composition.

16. The electrical component of claim 15, comprising industrial motors, starter generators and motors, and high power electronics.

17. The electrical component of claim 15, wherein the coating is applied by an impregnation technique.

18. The electrical component of claim 15, wherein the coating is applied by a doctor blade technique, spraying, or sprinkling.

19. The electrical component of claim 15, wherein the coating is cured at a temperature between about 150 degrees Celsius and about 170 degrees Celsius, under atmospheric conditions.

20. The electrical component of claim 15, wherein the coating has a thermal conductivity ranging from about 1 W/m-K to about 3 W/m-K.

21. The electrical component of claim 15, wherein the coating has a dissipation factor in a range from about 0.5 percent to about 1.5 percent at a temperature between about room temperature and about 150 degrees Celsius.
